(19) United States
(12) Patent Application Publication
(10) Pub. No.: US 2025/0343707 A1
(43) Pub. Date: Nov. 6, 2025

(54) COMMUNICATION SYSTEM FOR A VEHICLE

(71) Applicant: Rivian IP Holdings, LLC, Irvine, CA (US)

(72) Inventors: Pramod SRINIVASAN, San Jose, CA (US); Christian CASSAR, Leeds (GB); Pratik SINGH, Mountain View, CA (US); Daniel CHEN, Palo Alto, CA (US); Nicholas Charles DEUBERT, Cumberland, RI (US); Hicham HASSOUBI, South Windsor, CT (US); Anirban KUNDU, Fremont, CA (US); Jibin TOMY, Mountain View, CA (US)

(21) Appl. No.: 19/190,291

(22) Filed: Apr. 25, 2025

Related U.S. Application Data
(60) Provisional application No. 63/642,577, filed on May 3, 2024.
(60) Provisional application No. 63/719,043, filed on Nov. 11, 2024.

(51) Int. Cl. H04L 12/40; G06F 21/64; G06F 21/85

(52) U.S. Cl. CPC H04L 12/40013; G06F 21/64; G06F 21/85; H04L 2012/40215; H04L 2012/40273

(57) ABSTRACT

In certain embodiments, a communication system includes a network server configured to provide a secure data fabric, a network device connected to the secure data fabric, and a vehicle in communication with the network and connected to the secure data fabric. The secure data fabric includes cell modules, and each cell module includes a fabric hub, a vehicle model, a signal model, and a first protocol with publication and subscription. The vehicle includes electronic control units (ECUs) connected to an ECU bus. One of the ECUs includes a fabric node, and is configured to exchange messages, including the data from the vehicle model, with the fabric hub according to the first protocol, convert the data from the vehicle model to data from the signal model, and exchange messages, including the data from the signal model, with the ECUs according to a second protocol.

### CROSS-REFERENCE TO RELATED APPLICATIONS

This application claims the benefit of U.S. Provisional Patent Application Ser. Nos. 63/642,577 (filed on May 3, 2024) and 63/719,043 (filed on Nov. 11, 2024), the contents of which are incorporated herein in their entireties.

### INTRODUCTION

The present disclosure relates to communications systems. M ore particularly, the present disclosure relates to a communication system for a vehicle

### SUMMARY

Embodiments of the present disclosure advantageously provide a communication system for a vehicle.

In certain embodiments, a communication system comprises at least one network server in communication with a network, a network device in communication with the network and connected to the secure data fabric, and at least one vehicle in communication with the network and connected to the secure data fabric. The network server is configured to provide a secure data fabric that comprises cell modules, a vehicle model, a signal model, and a first protocol including publication and subscription. Each cell module includes a fabric hub. The network device is configured to exchange messages with the network server according to the first protocol, and the messages including data from the vehicle model. The vehicle comprises electronic control units (ECUs) connected to an ECU bus. The ECUs include a first ECU including a fabric node in communication with the fabric hub of one of the cell modules. The first ECU is configured to exchange messages with the fabric hub according to the first protocol, the messages including the data from the vehicle model, convert the data from the vehicle model to data from the signal model, and exchange messages with the ECUs according to a second protocol, the messages including the data from the signal model.

### BRIEF DESCRIPTION OF THE DRAWINGS

FIG. 1 depicts a diagram of an example electric vehicle, in accordance with embodiments of the present disclosure.

FIG. 2 depicts a block diagram of example components of an electric vehicle, in accordance with embodiments of the present disclosure.

FIG. 3A depicts a block diagram of an example communication system, in accordance with embodiments of the present disclosure.

FIG. 3B depicts another block diagram of the example communication system depicted in FIG. 3A, in accordance with embodiments of the present disclosure.

FIG. 3C depicts a block diagram of an example electronic control unit bus gateway, in accordance with embodiments of the present disclosure.

FIG. 4 depicts a portion of an example vehicle model (VM) definition file, in accordance with embodiments of the present disclosure.

FIG. 5 depicts an example data flow for a communication system, in accordance with embodiments of the present disclosure.

FIG. 6 depicts a block diagram of an example network computer, in accordance with embodiments of the present disclosure.

FIG. 7A depicts a block diagram of another example communication system, in accordance with embodiments of the present disclosure.

FIG. 7B depicts another block diagram of the example communication system depicted in FIG. 7A, in accordance with embodiments of the present disclosure.

FIG. 7C depicts another block diagram of the example communication system depicted in FIG. 7A, in accordance with embodiments of the present disclosure.

FIG. 8A depicts a block diagram of another example communication system, in accordance with embodiments of the present disclosure.

FIG. 8B depicts another block diagram of the example communication system depicted in FIG. 8A, in accordance with embodiments of the present disclosure.

### DETAILED DESCRIPTION

Vehicles use various ad hoc communication techniques to share data between applications running on network devices and applications running on the vehicle electronic control units (ECUs). After the data are generated, the data are sent through multiple communication channels and translations before the data are received for further processing. Additionally, in existing communication systems, there is no single representation for the data states and services that are available across the network devices and the vehicle ECUs. Further, applications running on network devices and vehicle ECUs must constantly revise the underlying code to accommodate changes in data structures and service application programming interfaces (APIs). Managing these platform and architectural variations becomes complicated and cumbersome. Consequently, it is difficult to share data and services across network devices and vehicle ECUs.

Embodiments of the present disclosure advantageously provide a communication system for a vehicle that includes a uniform communication fabric (also known as a secure data fabric) that is simple, convenient, efficient, and less prone to error. The secure data fabric encompasses data transmitted between network applications running on network devices and vehicle applications running on the ECUs, data transmitted between vehicle applications running on different ECU's, and data transmitted between vehicle applications running on the same ECU.

The network devices may include network servers, “cloud-based” network servers that provide cloud computing services, smartphones, personal computers, etc. The vehicle has a control system that includes a number of ECUs that are coupled to an ECU bus. Each ECU includes one or more processors that are configured to execute one or more software modules that are stored in a memory. At least one ECU includes a wireless transceiver that may be coupled to a wireless network (such as a cellular network, a WiFi network, etc.) that is coupled to a wide area network (WAN, such as the Internet, etc.).

The network applications and the vehicle applications work together to provide a suite of services within the communication system, such as backend services, user services, vehicle services, etc. M ore particularly, the network devices and the vehicle ECUs are nodes that form a distributed cluster for the secure data fabric. Data are generated by “producer” applications running on the network devices or the vehicle ECUs, transmitted through the secure data fabric, and received by “consumer” applications running on the vehicle ECUs or the network devices. Advantageously, an application that is connected to the secure data fabric on one node may produce data that may be consumed by other applications that are connected to the secure data fabric on any node.

The secure data fabric includes a messaging protocol and supporting infrastructure that provides the framework for producer applications to publish data and offer services to consumer applications, and for consumer applications to subscribe to published data and request services from producer applications. In certain embodiments, the communication messaging protocol implements the Neural Autonomic Transport System (NATS) protocol. In other embodiments, the communication messaging protocol may implement Apache Kafka, RabbitMQ, Apache Pulsar, gRPC, etc.

The communication system provides many technical advantages over existing ad hoc communication techniques. The secure data fabric provides eventual data consistency (also known as “at least once” semantics) by providing the latest state of the relevant data to consumer applications, followed by the remaining states of the relevant data, followed by subsequent updates to the relevant data. Alternatively, the secure data fabric may also compress the changes to the data states to the last known data state, which is provided to the consumer applications. The secure data fabric provides partition tolerance so that nodes in the distributed cluster may operate independently, and may synchronize (opportunistically) based on connectivity to the secure data fabric. When a data state changes, the secure data fabric provides asynchronous event notifications with flow control to the consumer applications. The data state changes may also be prioritized. In addition to data, a producer application may also provide services to consumer applications connected to the secure data fabric, which is analogous to a remote procedure call (RPC).

While aspects of the present disclosure are discussed in the context of an electric vehicle (EV), the disclosure supports any type of vehicle, such as an internal combustion engine vehicle (ICEV), a hybrid electric vehicle (HEV), etc.

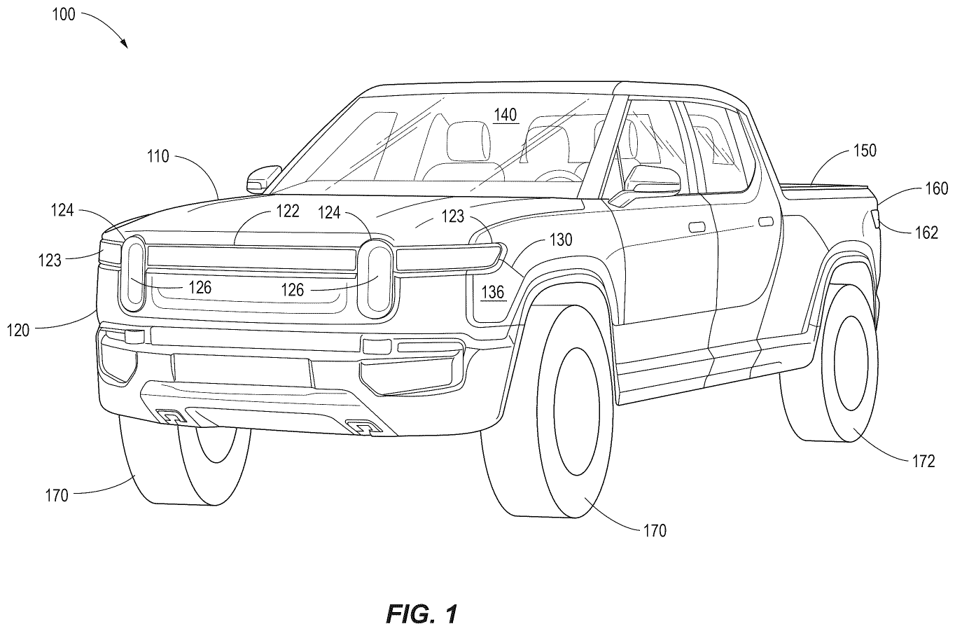

FIG. 1 depicts a diagram of an example electric vehicle 100, in accordance with embodiments of the present disclosure.

Electric vehicle 100 includes, inter alia, a frame and body 110, an electrical power storage and distribution system, a propulsion system, a suspension system, a steering system, a control system, auxiliary and accessory systems (such as thermal management, lighting, wireless communications, navigation, etc.), etc.

Generally, body 110 may be directly or indirectly mounted to a frame (i.e., body-on-frame construction), or body 110 may be formed integrally with a frame (i.e., unibody construction). Body 110 includes, inter alia, front end 120, front light bar 122, front turn lights 123, stadium light rings 124, headlights 126, charging port 130 with charging port cover 136 concealing charging connector socket, driver/passenger compartment or cabin 140, bed 150, rear end 160 with rear tail lights 162, a rear light bar, etc. Electric vehicle 100 may be a pickup truck, a sport utility vehicle (SUV) in which bed 150 is replaced by an extension of cabin 140, or a sedan in which bed 150 is replaced by a trunk. In certain embodiments, electric vehicle may be an electric delivery vehicle, an electric cargo van, etc.

The propulsion system may include, inter alia, one or more ECUs, one or more electric drive unit (EDUs), front wheels 170, rear wheels 172, etc. The electrical power storage and distribution system may include, inter alia, one or more ECUs, a battery enclosure including a housing containing a traction battery, a vehicle charging subsystem including charging port 130, a high voltage (HV) wiring harness connecting the traction battery to the other HV electrical system components, such as the EDUs, etc.

A single motor EDU may be used to drive front wheels 170 (front wheel drive) or rear wheels 172 (rear wheel drive). Additionally, a single motor EDU may be used to drive front wheels 170 and a single motor EDU may be used to drive rear wheels 172 (four wheel drive). A dual motor EDU may be used to independently drive front wheels 170 (independent front wheel drive) or rear wheels 172 (independent rear wheel drive). Additionally a dual motor EDU may be used to independently drive both front wheels 170 and a dual motor EDU may be used to independently drive both rear wheels 172 (independent four wheel drive).

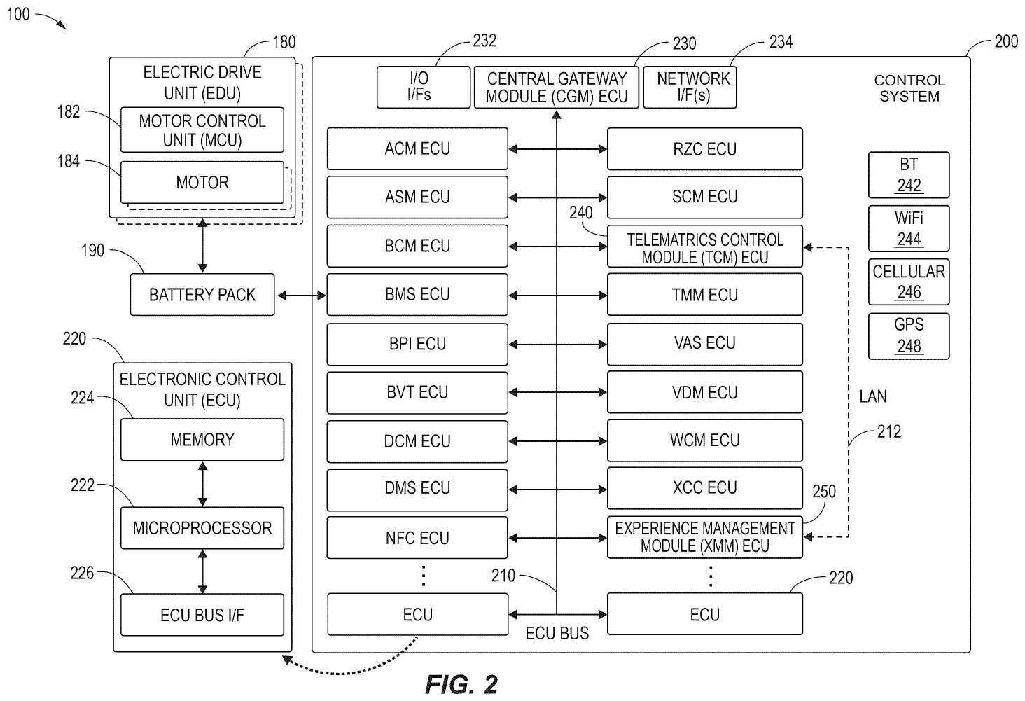

FIG. 2 presents a block diagram of example components of electric vehicle 100, in accordance with embodiments of the present disclosure.

Generally, electric vehicle 100 includes control system 200 that is configured to perform the functions necessary to operate electric vehicle 100. In certain embodiments, control system 200 includes a number of ECUs 220 coupled to ECU bus 210 (such as a controller area network or CAN bus, a local area network or LAN, etc.). Each ECU 220 performs a particular set of functions, and includes, inter alia, one or more processors 222 coupled to memory 224 and ECU bus interface (I/F) 226. ECUs 220 may include central gateway module (CGM) ECU 230, telematics control module (TCM) ECU 240, experience management module (XMM) ECU 250, etc.

ECU bus 210 implements a message based communication protocol over a physical infrastructure or layer. For example, ECU bus 210 may be a CAN bus that implements ISO 11898 (CAN protocol) over twisted, differential pair wiring that carries the CAN_H and CAN_L data signals. In another example, ECU bus 210 may be a LAN that implements IEEE 802.3 (Ethernet protocol) over wired cables (such as a CAT-8 Ethernet cable, etc.), fiber optic cables, etc. In some embodiments, control system 200 may include an additional LAN 212 that connects certain ECUs 220, such as TCM ECU 240, XMM ECU 250, etc. LAN 212 may be configured to communicate data between these particular ECUs without interfering with the flow of data through ECU bus 210.

Processor 222 may be a microcontroller unit, a microprocessing unit, a central processing unit (CPU), a programmable logic device (PLD), a complex PLD, a field programmable gate array (FPGA), an application specific integrated circuit (ASIC), etc. Memory 224 may include volatile and non-volatile memory, such as random access memory (RAM), static RAM (SRAM), dynamic RAM (DRAM), read only memory (ROM), flash memory, universal flash storage (UFS), solid state drives (SSDs), etc. Processor 222 may execute a real time operating system (RTOS), such as VxWorks, Integrity, a proprietary RTOS, etc. In certain embodiments, one or more ECUs 220 may include one or more multi-core processors 222 that execute an operating system that supports high-volume multithreading applications (such as Linux, Unix, BSD, etc.), etc., such as TCM ECU 240, XMM ECU 250, etc.

In certain embodiments, control system 200 may include a number of system-on-chips (SoCs). Each SoC may include a number of multi-core processors coupled to a high-speed interconnect and on-chip memory that provide more robust functionality and performance than a single ECU 220. Accordingly, each SoC may combine the functionality provided by several ECUs 220. For example, the functionality performed by several ECUs may be performed by one or more virtual machines that are hosted by a SoC. Similarly, the functionality performed by several ECUs may be performed by one or more virtual machines that are hosted by a more robust ECU with a number of single-core or multi-core processors.

Control system 200 may be coupled to sensors (such as cameras, radar sensors, ultrasonic sensors, etc.), actuators (such as electric, hydraulic, pneumatic, etc.), input/output (I/O) devices, as well as other components within the propulsion system, the electrical power storage and distribution system, the suspension system, the steering system, the auxiliary and accessory systems, etc., such as EDU 180 including motor control unit (MCU) 182 and motor 184, battery pack 190, etc.

CGM ECU 230 provides a central communications hub for electric vehicle 100. CGM ECU 230 includes (or is coupled to) I/O I/F(s) 232 to receive data from, and send commands to, various vehicle components, such as sensors, actuators, input devices, output devices, etc. CGM ECU 230 also includes (or is coupled to) network I/F(s) 234 to provide network connectivity through ECU bus ports, local interconnect network (LIN) ports, Ethernet ports, etc.

CGM ECU 230 may route messages (including commands, data, etc.) over ECU bus 210 from one ECU 220 to another ECU 220, or from one ECU 220 to multiple ECUs 220 (such as broadcast messages, etc.). In one example, CGM ECU 230 may receive a message from a source ECU 220, process the message to determine, inter alia, the destination ECU 220, and then transmit the message to the destination ECU 220. In another example, CGM ECU 230 may simply arbitrate ECU bus 210 to allow the source ECU 220 to send a message directly to the destination ECU 220.

CGM ECU 230 may receive data from a sensor, an I/O device, a vehicle component, etc., and then send a message containing the data to the appropriate ECU 220 over ECU bus 210. Similarly, CGM ECU 230 may receive a message containing a command or data from a source ECU 220, and then send the command or the data to the appropriate actuator, I/O device, vehicle component, etc. Additionally, CGM ECU 230 may manage the vehicle mode (such as road driving mode, off-roading mode, tow mode, camping mode, parked mode, etc.), and may control certain vehicle components related to transitioning from one vehicle mode to another vehicle mode.

TCM ECU 240 which provides a wireless communications hub for electric vehicle 100. TCM ECU 240 may include or may be coupled to Bluetooth (BT) or Bluetooth Low Energy (BLE) transceiver 242, WiFi transceiver 244, cellular network transceiver 246 configured to transmit and receive data over a cellular data connection, etc. TCM ECU 240 may also include global positioning system (GPS) receiver 248.

In certain embodiments, control system 200 may also include, inter alia, autonomy control module (ACM) ECU, autonomous safety module (ASM) ECU, body control module (BCM) ECU, battery management system (BM S) ECU, battery power isolation (BPI) ECU, balancing voltage temperature (BVT) ECU, door control module (DCM) ECU, driver monitoring system (DM S) ECU, near-field communication (NFC) ECU, rear zone control (RZC) ECU, seat control module (SCM) ECU, thermal management module (TMM) ECU, vehicle access system (VAS) ECU, winch control module (WCM) ECU, motor control unit (XCC) ECU, etc.

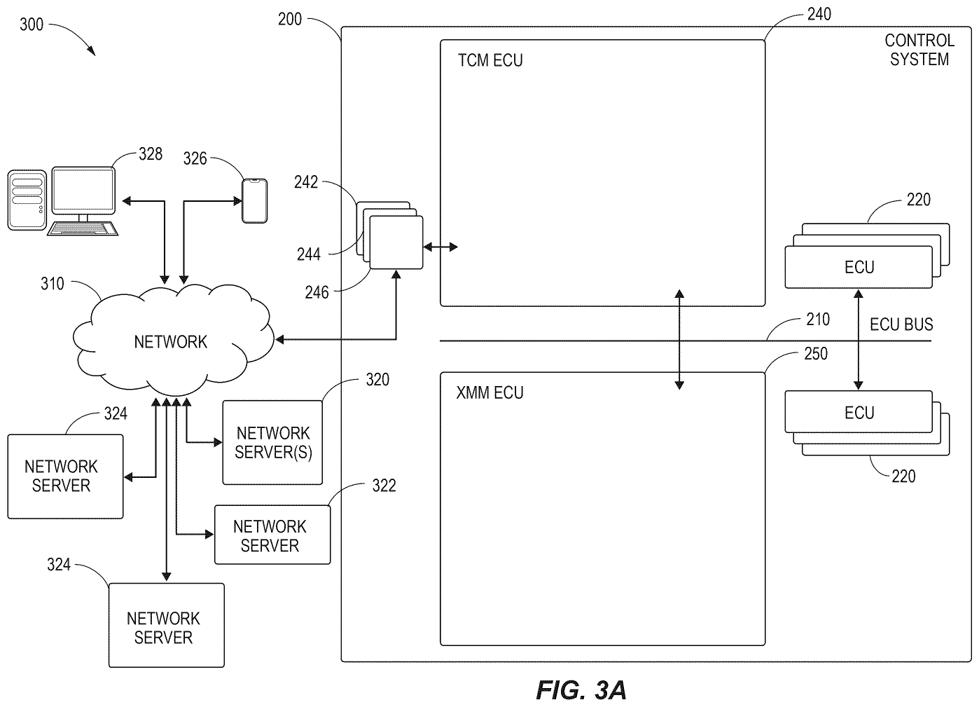

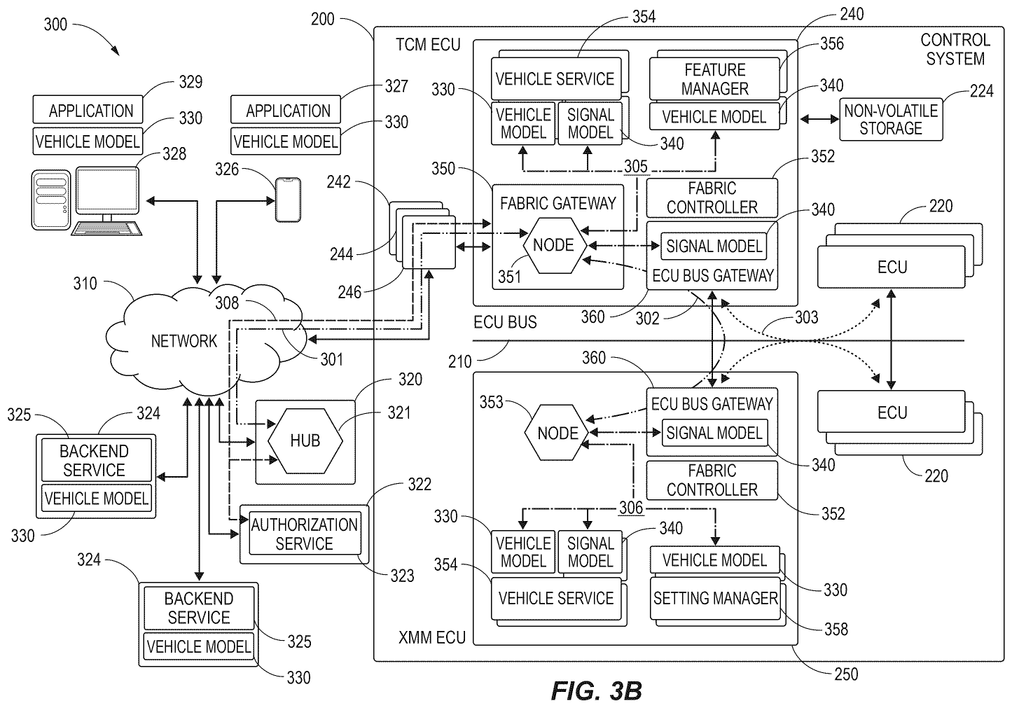

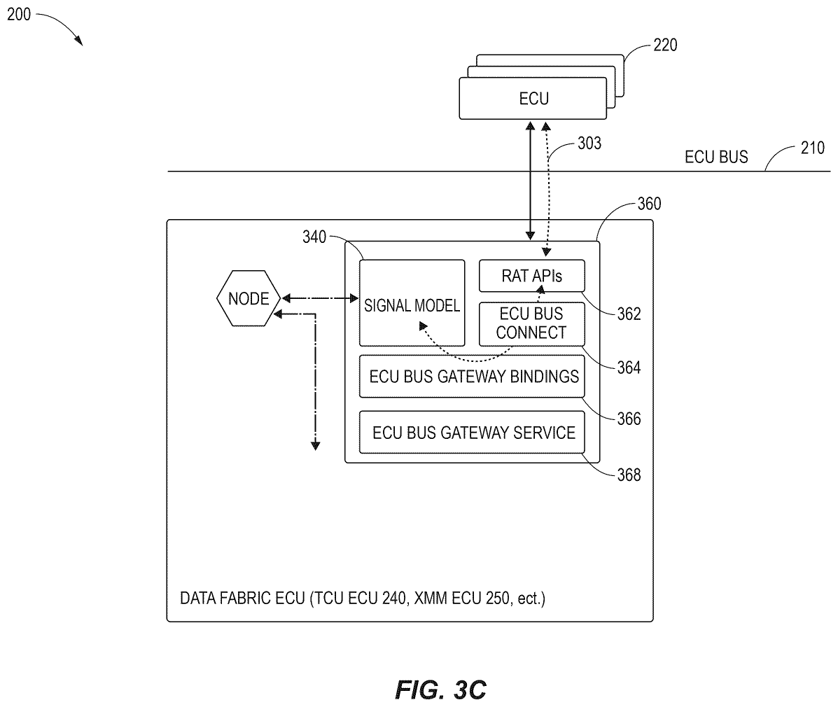

FIG. 3A depicts a block diagram of communication system 300, in accordance with embodiments of the present disclosure.

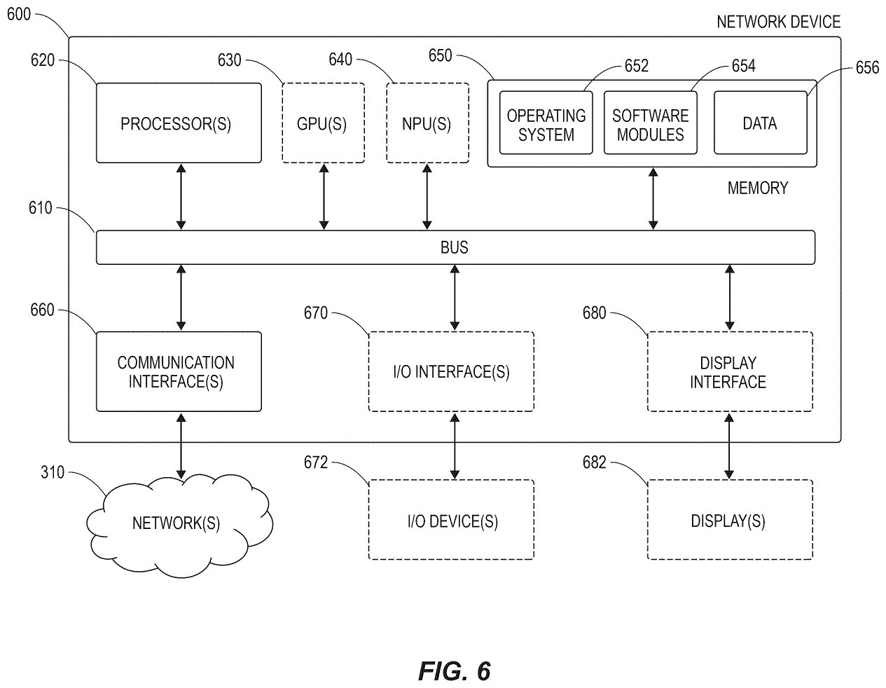

In certain embodiments, communication system 300 includes, inter alia, network 310, network devices such as network servers 320, 322, 324, mobile device 326 (such as a smartphone, etc.), personal computer 328, etc., and ECUs 220 of control system 200, such as TCM ECU 240 with BT/BLE transceiver 242, WiFi transceiver 244, and cellular network transceiver 246, and XMM ECU 250, etc. The architecture of the network devices are described with respect to FIG. 6.

Network 310 may include one or more LANs, wireless LANs (WLANs), WANs (such as the Internet, etc.), etc., which may execute various network protocols, such as, for example, Ethernet, Bluetooth, WiFi, etc. Network 310 may also include various combinations of wired and/or wireless physical layers, such as, for example, copper wire or coaxial cable networks, fiber optic networks, Bluetooth wireless networks, WiFi wireless networks, CDMA, FDMA and TDM A cellular wireless networks, etc.

In certain embodiments, network servers 320, 322, 324 may be coupled to a LAN (or respective LANs) that is coupled to a WAN (such as the Internet, etc.). Mobile device 326 may be coupled to a wireless network (such as a Bluetooth network, a WiFi network, a cellular network, etc.) that is coupled to the WAN. Personal computer 328 may be coupled to a LAN or WLAN that is coupled to the WAN. BT/BLE transceiver 242 may be coupled to a Bluetooth network device, which is coupled to the LAN. WiFi transceiver 244 may be coupled to a WiFi wireless network which is coupled to the WAN. Cellular network transceiver 246 may be coupled to a CDMA, FDMA or TDMA cellular wireless network, which is coupled to the WAN. Generally, network 310 includes the LANs and WANs necessary to interconnect network servers 320, 322, 324, mobile device 326, personal computer 328, and electric vehicle 100.

Network servers 320, 322, 324 provide the functionality necessary to implement the communication messaging protocol and other control protocols within the secure data fabric. In certain embodiments, network servers, 320, 322, 324 may be physical network servers coupled to network 310. In certain other embodiments, network servers, 320, 322, 324 may be “cloud-based” servers (also known as virtual servers) whose functionality is distributed among one or more physical network servers coupled to network 310. A portion of network 310 and these physical network servers may form a “cloud” to which mobile device 326 and electric vehicle 100 may be coupled using wireless LANs, and to which personal computer 328 may be coupled using a wired or wireless LAN. In other words, network servers 320, 322, 324 may provide a cloud computing platform that is configured to provide cloud computing services.

FIG. 3B depicts another block diagram of communication system 300 depicted in FIG. 3A, in accordance with embodiments of the present disclosure. In addition to the physical components of communication system 300, certain functional modules, data models, and data flow paths are also depicted. Generally, a functional module may include one or more software modules that are configured to be executed by a local processor or controller, a combination of software modules and programmable logic devices and/or hardware components, etc.

Network server 320 provides the functionality necessary to implement the communication messaging protocol within the secure data fabric. Network server 320 may include network servers that provide a fabric hub 321 to which fabric nodes 351, 353 may be directly or indirectly connected. For example, fabric node 353 may be connected to fabric node 351, and fabric node 351 may be connected to fabric hub 321. In certain embodiments, network server 320 may be a NATS server and fabric nodes 351 and 353 may be NATS leaf nodes. The NATS server may include a server cluster with one or more NATS network servers that run in NATS clustered mode. Clustering NATS servers provides a high volume of messaging, resiliency, and a high availability.

Network server 322 may execute authorization service module 323 which issues data and service authorizations to network applications and vehicle applications that connect to the secure data fabric at network server 320. In certain embodiments, the authorizations may be JSON Web Tokens (J WTs) that include a set of claims that describe the data and services that the network or vehicle application may access within communication system 300. For example, TCM ECU 240 may receive a JWT over data flow path 308 that includes claims that define the data and services to which the vehicle applications may publish and subscribe. The JWT token is also provided to network server 320, which enforces the claims within the secure data fabric.

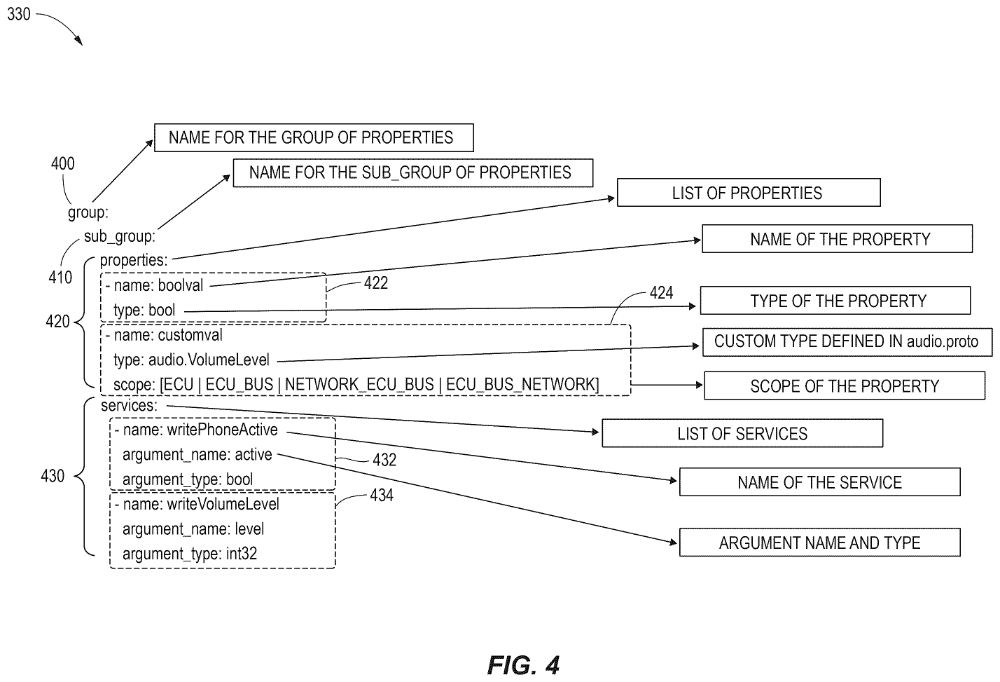

Network servers 324 may execute one or more backend service modules 325 that use vehicle model 330 to provide various services for mobile device 326, personal computer 328, and electric vehicle 100, such as serving or supporting a network application on mobile device 326 (such as an iPhone “App,” a web page for a browser, etc.), serving or supporting a network application on personal computer 328 (such as a web page for a browser, etc.). Backend service module 325 may also provide services for electric vehicle 100, such as subscription services, Over-The-Air (OTA) services, etc. For example, a subscription service may manage software subscriptions for electric vehicle 100 (such as functional modules hosted by TCM ECU 240, XMM ECU 250, ECUs 220, etc.), an OTA service may manage OTA software updates to electric vehicle 100, etc. Vehicle model 330 is discussed with respect to FIG. 4.

Mobile device 326 may execute one or more network applications 327 (such as an iPhone “App”, a browser, etc.) that use vehicle model 330 to provide various services for the user, such as remote start, lock doors, unlock doors, open frunk, locate vehicle, etc. Similarly, personal computer 328 may execute one or more network applications 329 (such as a browser, etc.) that use vehicle model 330 to provide various services for the user, such as remote start, lock doors, unlock doors, open frunk, locate vehicle, etc.

TCM EDU 240 may include one or more multi-core processors 222 that execute an operating system that supports high-volume multithreading applications (such as Linux, Unix, BSD, etc.). Various functional modules may be hosted by TCM EDU 240, including fabric gateway 350, fabric controller 352, one or more vehicle service instances or modules 354 (such as a “body” service module, a “vehicle” service module, etc.), one or more feature manager modules 356, ECU bus gateway 360, etc. ECU bus gateway 360 exchanges messages with ECUs 220 over ECU bus 210 (through data flow path 303), and is discussed in more detail with respect to FIG. 3C.

Fabric gateway 350 is a component of the secure data fabric that acts as a bridge between the vehicle applications and the network applications. Fabric gateway 350 includes fabric node 351, which is connected to fabric hub 321 through data flow path 301 and to fabric node 353 through data flow path 302. Fabric gateway 350 consumes data from vehicle service modules 354 and feature manager modules 356 through data flow paths 305, and sends data for publication by the secure data fabric to network server 320 through data flow path 301. Fabric gateway 350 also consumes data from the secure data fabric by receiving published data from network server 320 through data flow path 301, and forwards the published data to vehicle service modules 354 and feature manager modules 356 through data flow paths 305. Fabric gateway 350 also forwards the published data to XMM ECU 250 through data flow path 302. Fabric gateway 350 also provides replication of data state and services.

In certain embodiments, fabric hub 321 is a NATS server cluster, and fabric nodes 351 and 353 are NATS leaf nodes, as discussed above. The NATS leaf node on TCM ECU 240 is connected to the NATS server cluster (network server 320) through data flow path 301, and to the NATS leaf node on XMM ECU 250 through data flow path 302. Accordingly, fabric gateway 350 may forward data for publication to the secure data fabric that is received from XMM ECU 250 to network server 320 through data flow path 301. Similarly, fabric gateway 350 may forward published data received from network server 320 to XMM ECU 250 through data flow path 302. In some embodiments, fabric gateway 350 may use public key infrastructure (PKI) to verify the data signatures of the incoming payload.

In certain embodiments, fabric gateway 350 may comprise one or more processors, controllers, etc., that are coupled to processor 222 and memory 224 of TCM ECU 240 and configured to implement the functionality described above. In other embodiments, fabric gateway 350 may comprise one or more software modules that are executed by processor 222 of TCM ECU 240.

Fabric controller 352 manages the streams in the secure data fabric that store and forward messages. In certain embodiments, fabric controller 352 configures and controls NATS server instances executing on TCM ECU 240, manages streams in the secure data fabric on electric vehicle 100, monitors the health of the streams, etc. In certain embodiments, the secure data fabric may include bulk streams, event streams, and state streams. A bulk stream from an electric vehicle 100 may include anonymized vehicle data, a pattern of user-selected options or commands, etc. An event stream from an electric vehicle 100 may include remote commands, etc. A state stream from an electric vehicle 100 may include compacted vehicle state data.

In certain embodiments, fabric controller 352 may comprise one or more processors, controllers, etc., that are coupled to processor 222 and memory 224 of TCM ECU 240 and configured to implement the functionality described above. In other embodiments, fabric controller 352 may comprise one or more software modules that are executed by processor 222 of TCM ECU 240.

Each vehicle service instance or module 354 is a vehicle application that accesses vehicle model 330 and signal model 340 to provide data and services to other vehicle applications and network applications. Generally, vehicle model 330 is not dependent upon any particular vehicle platform, while signal model 340 provides the underlying data schema for the particular vehicle platform. Advantageously, vehicle applications and network applications use vehicle model 330 as a standard data model that governs the organization and accessibility of data and services across the secure data fabric. Each vehicle service module 354 maps data defined within signal model 340 to data defined within vehicle model 330. Vehicle platform-specific data and services may be represented as capabilities within vehicle model 330.

Each feature manager module 356 may access vehicle model 330 to provide data and services related to a particular feature within vehicle model 330, such as wireless/Long-Term Evolution (LTE) management, OTA management, etc. In certain embodiments, the data and services may be related to a particular group or subgroup within vehicle model 330, as discussed below.

XMM ECU 250 may include one or more multi-core processors 222 that execute an operating system that supports high-volume multithreading applications (such as Linux, Unix, BSD, etc.). Various functional modules may be hosted by XMM ECU 250, including one or more vehicle service modules 354 such as an “energy” service module, an “audio” service module, an “hvac” service module, etc.), one or more setting manager modules 358, ECU bus gateway 360, etc. XMM ECU 250 may also host a fabric controller 352, as discussed above. Each setting manager module 356 may access vehicle model 330 to provide data and services related to a particular setting within vehicle model 330, such as energy management, audio/amplifier management, Heating, Ventilation, and Air Conditioning (HVAC) management, etc.

Fabric node 353 consumes data from vehicle service modules 354 and setting manager modules 358 through data flow paths 306, and sends data for publication by the secure data fabric to fabric gateway 350 through data flow path 302 for transmission to network server 320 through data flow path 301. Fabric node 353 also consumes data from the secure data fabric by receiving published data (originating from network server 320) from fabric gateway 350 through data flow path 302, and forwards the published data to vehicle service modules 354 and setting manager modules 356 through data flow paths 306.

Referring to FIG. 4, a portion of vehicle model 330 is depicted, in accordance with embodiments of the present disclosure.

Generally, vehicle model 330 provides an interface definition language (IDL) that establishes the interface between data producers and data consumers in terms of properties 420 (data definitions) and services 430 (processes related to the data definitions). Properties 420 and services 430 may be hierarchically structured within vehicle model 330 under one or more groups 400. In certain embodiments, a group 400 may have one or more subgroups 410, as depicted in FIG. 4.

Rather than defining the entire IDL within a single file, vehicle model 330 may be split into multiple files based on general categories or subjects, and each file may have a particular extension (such as body.rvm, vehicle.rvm, energy.rvm, audio.rvm, hvac.rvm, etc.). The IDL may define a mechanism to represent data types, or use a representation such as protocol buffer format, etc. For example, a related protocol buffer file may be generated for each vehicle model file to define the relevant data in a protocol buffer format (such as body.proto, vehicle.proto, energy.proto, audio.proto, hvac.proto, etc.).

Group 400 is simply named “group” for illustration purposes, but will typically be named for a category of data, such as “body”, “vehicle”, “energy”, “audio”, “hvac”, etc. Similarly, subgroup 410 is simply named “sub_group” for illustration purposes, but will typically be named for a sub-category of data within the particular category, such as a subgroup named “amplifier” for a group named “audio”, etc. The names “properties” and “services” are tags that distinguish the different sections of subgroup 410, i.e., properties 420 and services 430.

Property 422 defines a name (“boolval”) for illustration purposes, but will typically be named for a property, such as a name of “audio_power_on”. Property 422 also defines a data type (“bool”), which is a Boolean value (such as 0 or 1, true or false, yes or no, etc.).

Property 424 defines a name (“customval”), for illustration purposes, but will typically be named for a property, such as a name of “volume_level”. Property 424 also defines a data type (“audio.VolumeLevel”), which is a custom data type defined in a related protocol buffer file (such as audio.proto). Property 424 further defines a scope (“[ECU|ECU BUS|NETWORK_ECU_BUS|ECU_BUS_NETWORK]”), which defines the visibility of property 424.

Service 432 defines a name (“writePhoneActive”), an argument name (“active”), and an argument data type (“bool”). Similarly, service 434 defines a name (“writeVolumeLevel”), an argument name (“level”), and an argument data type (“int32”, which is a signed 32-bit integer).

In certain embodiments, a vehicle model compiler automatically generates a software development kit (SDK) for application and service providers to facilitate the communication and exchange of property data and service arguments over the secure data fabric. Table 1 presents the beginning of an example vehicle model 330 file named “body.rvm” that defines a “body” group, a “ride” subgroup, and a property named “ride_height_button_states.”

TABLE 1

```
body:
  ride:
    properties:
      - name: ride_height_button_states
      type: drive_modes.RideHeightButtonStates
      scope: ECU
      owner: VEHICLE_SERVICES_RIDE_MODES
```

Properties may include a “scope” that determines visibility within the secure data fabric. For example, the scope may be set to “ECU” to limit a property's visibility to the applications running on the local ECU, and to prevent the property from being shared beyond the local ECU. For another example, the scope may be set to “ECU_BUS” to limit a property's visibility to the applications running on the ECUs that are connected to the secure data fabric within control system 200 (such as TCM ECU 240, XMM ECU 250, etc.), and to prevent the property from being transmitted beyond electric vehicle 100. For a further example, the scope may be set to “NETWORK_ECU_BUS” to enable a property published by the network applications to be visible to the applications running on the ECUs that are connected to the secure data fabric within control system 200. Conversely, the scope may be set to “NETWORK_ECU_BUS” to enable a property published by applications running on the ECUs that are connected to the secure data fabric within control system 200 to be visible to the network applications.

To avoid implicit assumptions regarding the ownership of a property, an owner_id may be defined for each property (such as “owner”, etc.) that is unique across the secure data fabric. Only a network or vehicle application that has a client_id that matches the owner_id can modify and publish the property's data. However, the owner_id does not impose any restrictions on subscription to the property, which may be governed by the authorization for each network and vehicle application that accesses the secure data fabric. For example, if a network or vehicle application requests the publication of data for a property, the data will only be published by network server 320 if the client_id of the network or vehicle application matches the property's owner_id. In certain embodiments, only authorized applications may perform operations on the vehicle model.

In certain embodiments, multiple instances of the same property may be published by the same owner or by different owners. Instead of replicating the property multiple times to support multiple instances and owners, the property may define a primitive to represent multiple instances for the property that are published by different owners across different scopes. Advantageously, “scope_rules” may define the different scope types, and one scope may include “is_owner_publish_scope” set to “true,” which may be the default scope for publication.

Table 2 presents the beginning of an example vehicle model 330 file named “vehicle.rvm” that defines a “vehicle” group, a “towing” subgroup, a property named “trailer_info,” an “owner_publish_scope” set to true for the ECU_BUS_NETWORK scope, and a “multi_instance” set to “true” for the “ECU” scope.

TABLE 2

```
vehicle:
  towing:
    properties:
      - name: trailer_info
      type: drive_modes.TrailerInfo
      owner: GROUPED_SERVER_DRIVE_MODES
      scope_rules:
        - scope: ECU_BUS_NETWORK
        is_owner_publish_scope: true
        - scope: ECU_BUS_NETWORK
        - scope: ECU
        multi_instance: true
```

Attributes that change the way infrastructure manages the property may be added to the property. Attributes may be specified using an attribute field and a comma separated set of attribute keywords, such as “private,” “ephemeral,” etc.

In certain embodiments, certain properties are not be published from electric vehicle 100 unless the user (such as vehicle owner, the vehicle operator, etc.) has granted permission, such as vehicle location coordinates ({latitude, longitude}), etc. Attributes that relate to private or sensitive information may be designated as “private” within an attribute field of the relevant *.rvm file. If the property is marked as private, then the property will not be published outside of electric vehicle 100. A property may also be classified into predefined categories, and if the user has not given permission for a particular category, the property will not be published outside of electric vehicle 100.

Generally, properties are backed by streams that are saved to the non-volatile portion of memory 224, such as flash memory, a UFS, an SSD, etc. In many cases, properties may be saved to the volatile portion of memory 224 (such as RAM, SRAM, DRAM, etc.) rather than non-volatile memory. Saving properties to volatile memory also prevents premature failure of the non-volatile memory due to frequent writes. Adding “ephemeral” to the attribute field will save the properties in volatile memory rather than non-volatile memory.

Referring back to FIG. 3B, vehicle service modules 354 may be hosted by TCM ECU 240, XMM ECU 250, etc., consume data from signal model 340 that are specific to the vehicle platform, and present a unified vehicle model 330 to the network and vehicle applications that are connected to the secure data fabric. Vehicle service modules 354 may be split across functional boundaries enabling modularity, reliability and control. Vehicle service modules 354 also provide APIs, remote procedure calls, etc., that are used by other network and vehicle applications to manage the functionality.

Vehicle service instances or modules 354 are modular applications, which enhances control and reliability. For example, vehicle service modules 354 may include an audio service module that is configured to manage the vehicle's audio systems. The audio service module may offer various functionality to other network and vehicle applications thorough an API, such as “change Volume,” “muteVolume,” etc. The audio service module may also manage properties within vehicle model 330 defined within an audio.rvm file, such as “currentVolumeLevel,” “isPhoneActive,” etc. Similarly, vehicle service modules 354 may include an HVAC service module that is configured to manage the heating, ventilation, and air conditioning systems of electric vehicle 100. This modular setup provides clear functional responsibilities, and mitigates the possibility that a failure in one vehicle service module 354 doesn't disrupt the other vehicle service modules 354.

Advantageously, vehicle service modules 354 may operate on a more capable ECU 220 that includes one or more multi-core processors 222 that execute an operating system that supports high volume multithreading applications (such as Linux, Unix, BSD, etc.). The API offered by each vehicle service module 354 remains consistent regardless of which particular ECU 220 hosts the vehicle service module 354, and the APIs may be accessed by any network and vehicle application that is connected to the secure data fabric. In certain embodiments, an application that typically runs on an ECU 220 may be ported to a more capable ECU 220 and executed as a vehicle service module 354.

In certain embodiments, ECUs 220 communicate with one another by transmitting and receiving user datagram protocol (UDP) packets or messages over ECU bus 210. Other messaging protocols may also be used, such as transmission control protocol (TCP), etc. The UDP messages include information describing the state of electrical vehicle 100, and are consumed by applications that gather information or perform actions on behalf of the applications that produce the messages. In certain embodiments, each UDP message is identified by a 32-bit message ID and contains a set of vehicle signals or vehicle properties. Some UDP messages are cyclic and sent periodically, such as vehicle platform-specific messages.

In certain embodiments, ECU bus 210 is a CAN bus that has an associated Database CAN (DBC) file. The DBC file is a text-based, structured database that includes information about the messages, signals, and encoding scheme used by the ECUs 220 to transmit the UDP messages over the CAN bus. Advantageously, signal model 340 presents a vehicle platform-specific representation of the information defined in the DBC file. In certain embodiments, an SDK (API) may be generated from the signal representation in DBC file, and provided to vehicle applications to allow the signal model data to be generated from the UDP messages.

FIG. 3C depicts a block diagram of ECU bus gateway 360, in accordance with embodiments of the present disclosure.

ECU bus gateway 360 is configured to exchange UDP messages with ECUs 220 over ECU bus 210, and convert the vehicle signals within the UDP messages to signal model 340. In certain embodiments, ECU bus gateway 360 includes RAT A PIs 362, ECU bus connect module 364, ECU bus gateway bindings 366, ECU bus gateway service 368, and signal model 340.

In certain embodiments, ECU bus gateway 360 may comprise one or more processors, controllers, etc., that are coupled to processor 222 and memory 224 of TCM ECU 240 (or XMM ECU 250) and configured to implement the functional modules described above. In other embodiments, ECU bus gateway 360 may comprise one or more software modules that are executed by processor 222 of TCM ECU 240 (or XMM ECU 250). Generally, any secure data fabric capable ECU 220 includes ECU bus gateway 360, such as TCM ECU 240, XMM ECU 250, etc.

The secure data fabric advantageously provides an efficient mechanism for storing, distributing, and consuming vehicle signal information generated by ECUs 220. M ore particularly, the secure data fabric translates UDP messages, transmitted over ECU bus 210, into vehicle data that may be stored in volatile or non-volatile memory 224, and which can be used by vehicle applications running on TCM ECU 240, XMM ECU 250, or any other secure data fabric capable ECU 220.

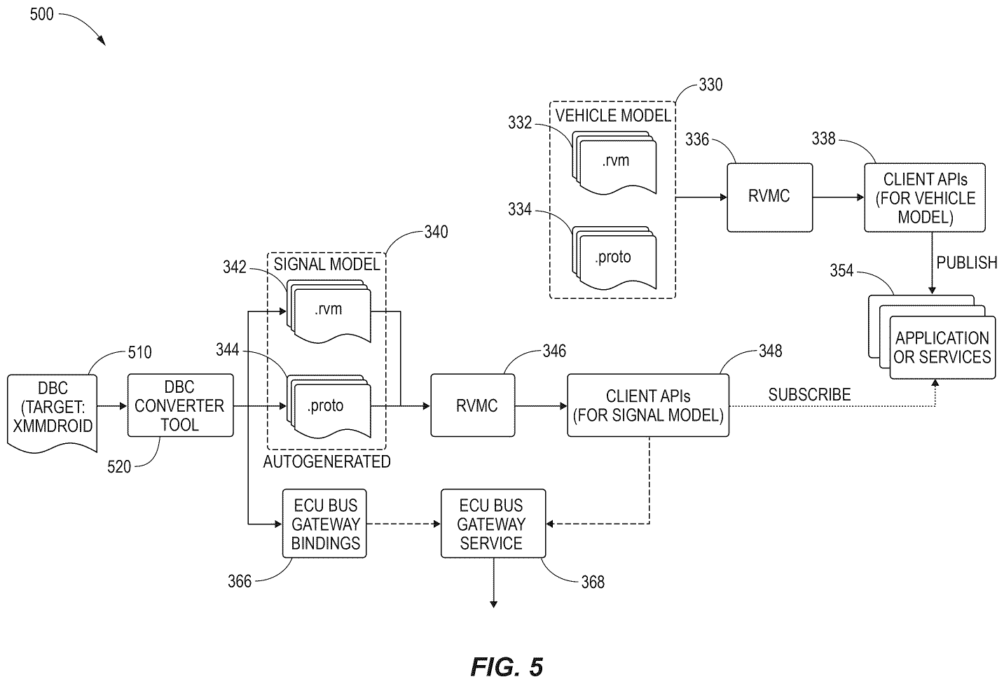

FIG. 5 depicts data flow 500 for communication system 300, in accordance with embodiments of the present disclosure.

As discussed above, DBC file 510 is a text-based, structured database that includes information about the messages, signals, and encoding scheme used by the ECUs 220 to transmit the UDP messages over the CAN bus. DBC converter tool 520 converts DBC file 510 into signal model 340, which is a vehicle platform-specific representation of the information defined in DBC file 510. Signal model 340, as well as ECU bus gateway bindings 366, are generated by DBC converter tool 520. As discussed above, signal model 340 may include a number of *.rvm files 342 and associated *.proto files 344. A specialized compiler 346 (“rvmc”) may generate API 348 based on signal model 340. API 348 may be expressed in any language of choice, and is provided to vehicle applications (such as vehicle service modules 354) to allow the signal model data to be generated from the UDP messages and consumed by the secure data fabric.

Similarly, vehicle model 330 may include a number of *.rvm files 332 and associated *.proto files 334. A specialized compiler 336 (“rvmc”) may generate API 338 based on vehicle model 330. API 338 may be expressed in any language of choice, and is provided to vehicle applications (such as vehicle service modules 354) to allow the vehicle model data to be generated and published to the secure data fabric.

FIG. 6 depicts a block diagram of network computer 600, in accordance with embodiments of the present disclosure.

Network servers 320, 322, 324 may include the same or similar components as network computer 600. Similarly, personal computer 328 may include the same components (or a subset of the components) as network computer 600. Mobile device 326 may include the same components (or a subset of the components) as network computer 600.

Network computer 600 may include one or more single core or multi core processors, specialized processors, etc., that are configured to execute various functionality in support of the secure data fabric. M ore particularly, network computer 600 may be coupled to network 310, input/output (I/O) device(s) 672, and display(s) 682. Network computer 600 includes bus 610 coupled to processor(s) 620, storage element or memory 650, communication interface(s) 660, I/O interface(s) 670, and display interface 680. In certain embodiments, network computer 600 may include one or more specialized processors, such as, for example, graphics processing units (GPUs) 630, neural processing units (NPUs) 640, field programmable gate arrays (FPGAs), etc. Generally, communication interface(s) 660 are coupled to network 310 using a wired or wireless connection, I/O interface(s) 670 are coupled to I/O device(s) 672 using a wired or wireless connection, and display interface 680 is typically coupled to display 682 using a wired or wireless connection.

Bus 610 is a communication system that transfers data between processor(s) 620, memory 650, communication interface(s) 660, I/O interface(s) 670, and display interface 680. In certain embodiments, bus 610 also transfers data between these components and GPU(s) 630, NPU(s) 640, and/or FPGAs, as well as other components not depicted in FIG. 6.

Processor(s) 620 include one or more general-purpose or application-specific processors that execute instructions to perform control, computation, input/output, etc, functions for network computer 600. Each processor 620 may include a single integrated circuit, such as a microprocessing device, or multiple integrated circuit devices and/or circuit boards working in cooperation to accomplish the appropriate functionality. In addition, processor(s) 620 may execute computer programs or modules, such as operating system 652, software modules 654, etc., stored within memory 650.

Generally, memory 650 stores instructions for execution by processor(s) 620 as well as data. Memory 650 may include a variety of non-transitory computer-readable medium that may be accessed by processor(s) 620 as well as other components. In various embodiments, memory 650 may include volatile and nonvolatile medium, non-removable medium and/or removable medium. For example, memory 650 may include any combination of random access memory (RAM), dynamic RAM (DRAM), static RAM (SRAM), read only memory (ROM), flash memory, cache memory, and/or any other type of non-transitory computer-readable medium.

Memory 650 contains various components for retrieving, presenting, modifying, and storing data 656. For example, memory 650 stores software modules 654 that provide functionality when executed by processor(s) 620. Operating system 652 provides operating system functionality for network computer 600. Software modules 654 provide various functionality, as discussed above. Data 656 may include data associated with operating system 652, software modules 654, etc.

Communication interface(s) 660 are configured to transmit data to and from network 310 using one or more wired and/or wireless connections.

I/O interface(s) 670 are configured to transmit and/or receive data from I/O device(s) 672. I/O interface(s) 670 enable connectivity between processor(s) 620, memory 650 and I/O device(s) 672 by encoding data to be sent from processor(s) 620 or memory 650 to I/O device(s) 672, and decoding data received from I/O device(s) 672 for processor(s) 620 or memory 650. Generally, data may be sent over wired and/or wireless connections. For example, I/O interface(s) 670 may include one or more wired communications interfaces, such as USB, Ethernet, etc., and/or one or more wireless communications interfaces, coupled to one or more antennas, such as WiFi, Bluetooth, cellular, etc.

Generally, I/O device(s) 672 provide input to network computer 600 and/or output from network computer 600. As discussed above, I/O device(s) 672 are operably connected to network computer 600 using a wired and/or wireless connection. I/O device(s) 672 may include a local processor coupled to a communication interface that is configured to communicate with network computer 600 using the wired and/or wireless connection. For example, I/O device(s) 672 may include a keyboard, mouse, touch pad, joystick, etc. Display interface 680 is configured to transmit image data from network computer 600 to display(s) 682. In certain embodiments, network computer 600 is not coupled to I/O device(s) 672 or display 682.

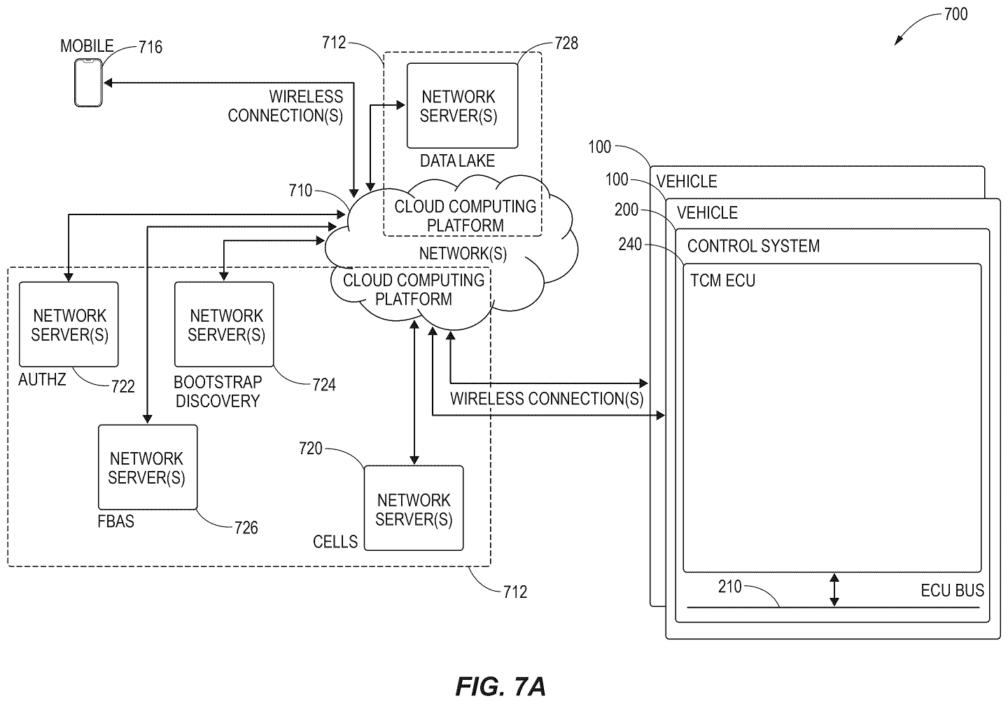

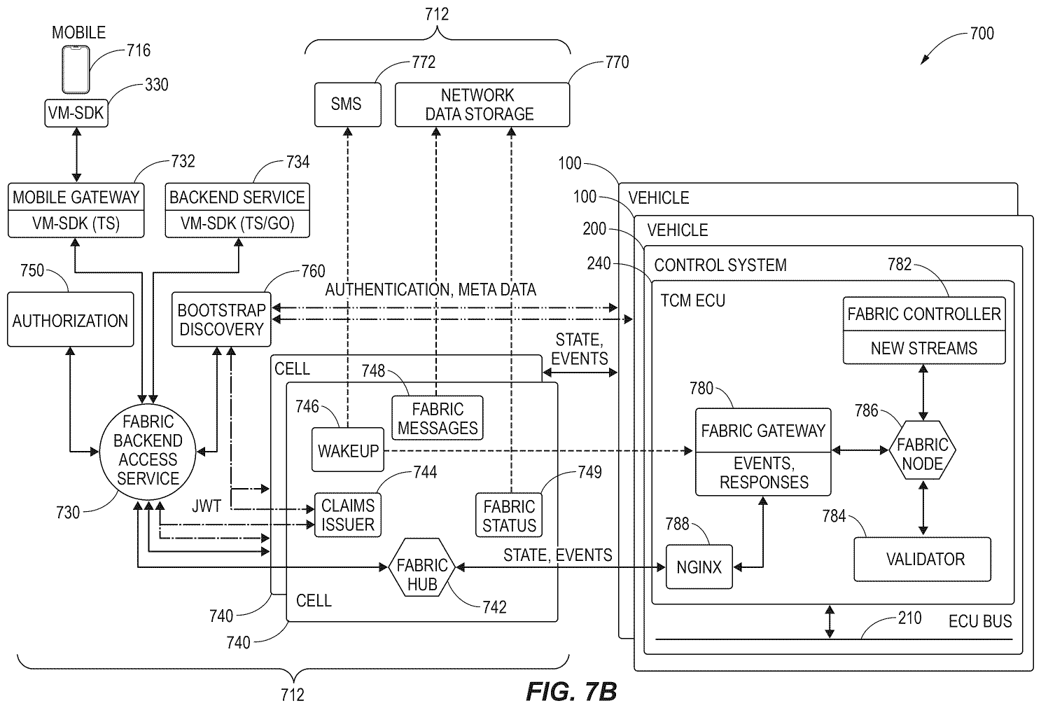

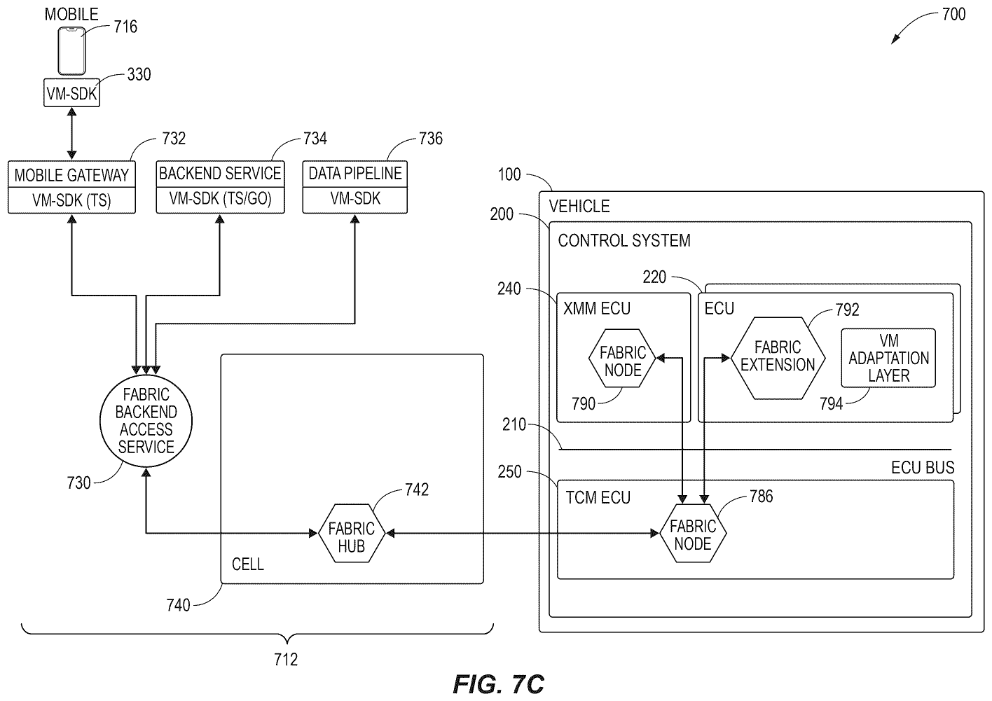

FIG. 7A depicts a block diagram of communication system 700, in accordance with embodiments of the present disclosure.

In certain embodiments, communication system 700 includes, inter alia, network 710, network devices, such as network servers 720, 722, 724, 726, 728, mobile device(s) 716, personal computer(s), etc., and electric vehicles 100. Each electric vehicle 100 includes a control system 200 with ECUs 220, such as TCM ECU 240 with BT/BLE transceiver 242, WiFi transceiver 244, cellular network transceiver 246, etc. (as depicted in FIG. 2). The architecture of the network devices are described with respect to FIG. 6.

As discussed above with respect to network 310, network 710 may include one or more LANs, wireless LANs (WLANs), WANs (such as the Internet, etc.), etc., which may execute various network protocols, such as, for example, Ethernet, Bluetooth, WiFi, etc. Network 710 may also include various combinations of wired and/or wireless physical layers, such as, for example, copper wire or coaxial cable networks, fiber optic networks, Bluetooth wireless networks, WiFi wireless networks, CDMA, FDMA and TDM A cellular wireless networks, etc.

In certain embodiments, network servers 720, 722, 724, 726, 728 may be coupled to a LAN (or respective LANs) that is coupled to a WAN (such as the Internet, etc.). Mobile device 716 may be coupled to a wireless network (such as a Bluetooth network, a WiFi network, a cellular network, etc.) that is coupled to the WAN. For control system 200 in each electric vehicle 100, BT/BLE transceiver 242 may be coupled to a Bluetooth network device, which is coupled to the WAN. WiFi transceiver 244 may be coupled to a WiFi wireless network which is coupled to the WAN. Cellular network transceiver 246 may be coupled to a CDMA, FDMA or TDMA cellular wireless network, which is coupled to the WAN. Generally, network 710 includes the LAN and WANs necessary to interconnect network servers 720, 722, 724, 726, 728, mobile device 716, and electric vehicles 100.

Network servers 720, 722, 724, 726, 728 provide the functionality necessary to implement the communication messaging protocol within the secure data fabric. In certain embodiments, network servers, 720, 722, 724, 726, 728 may be physical network servers coupled to network 710. In certain other embodiments, network servers, 720, 722, 724, 726, 728 may be “cloud-based” servers (also known as virtual servers) whose functionality is distributed among one or more physical network servers coupled to network 710. For example, a portion of network 710 and these physical network servers may form a “cloud” to which mobile device 716 and electric vehicles 100 may be coupled using wireless LANs. In other words, network servers 720, 722, 724, 726, 728 may provide a cloud computing platform 712 that is configured to provide cloud computing services associated with the secure data fabric.

FIG. 7B depicts another block diagram of communication system 700 depicted in FIG. 7A, in accordance with embodiments of the present disclosure.

In addition to the physical components of communication system 700, certain functional modules, data models, and data flow paths are also depicted. Generally, a functional module may include one or more software modules that are configured to be executed by a local processor or controller, a combination of software modules and programmable logic devices and/or hardware components, etc.

Advantageously, the secure data fabric supports event streams (without state compression), as well as compressed state streams to and from electric vehicle 100. For example, certain remote commands may require event streams from the electric vehicle 100. Each electric vehicle 100 dynamically discovers its metadata using a bootstrap service provided by bootstrap discovery module 760 (as discussed below). Additionally, each vehicle 100 provides a liveness service for authorized subscribers that may be consulted to check the active state of the electric vehicle 100.

In certain embodiments, network server 726 (or cloud computing platform 712) may host Fabric Backend Access Service (FBAS) module 730. Advantageously, FBAS module 730 simplifies the complexity of the interface to the secure data fabric (such as a direct interface to NATS), provides a remote procedure call interface (such as gRPC, etc.) with mutual authentication (such as mTLS, etc.), and supports publication, subscription, requests, and replies. FBAS module 730 is scalable by deploying additional FBAS modules 730 (or instances).

Applications executing on mobile device 716 access vehicle model 330 to provide various services for the user, such as remote start, lock doors, unlock doors, open frunk, locate vehicle, etc. (as discussed above). In certain embodiments, mobile gateway module 732 may act as a proxy between mobile device 716 and the secure data fabric (through FBAS module 730). Similarly, applications executing on other network devices or in cloud computing platform 712 access vehicle model 330 (as discussed above), and backend service module 734 may act as a proxy between these applications and the secure data fabric (through FBAS module 730). In certain embodiments, type script (TS) and GO programming language APIs may be autogenerated from the vehicle model 330, such as VM-SDK (TS) and VM-SDK (TS/GO).

In certain embodiments, network server 720 (or cloud computing platform 712) may host one or more cell modules 740 that provide independent and self-contained units of functionality for a certain number of electric vehicles 100 (such as 1,000 electric vehicles, 10,000 electric vehicles, 100,000 electric vehicles, etc.). Each cell module 740 also supports a certain number of data publications/second, such as 1,000, 10,000, 40,000, etc. Advantageously, cell module 740 is scalable by deploying additional cell modules 740 (or instances) to support additional electric vehicles 100 as the fleet expands.

Each cell module 740 may include, inter alia, fabric hub 742, claims issuer module 744, wakeup service module 746, fabric message module 748, and fabric status module 749.

As discussed above, fabric hub 742 is a central component of the secure data fabric, which provides the framework for producer applications to publish data and offer services to consumer applications, and for consumer applications to subscribe to published data and request services from producer applications. In certain embodiments, fabric hub 742 may be a NATS server cluster (as discussed above).

Claims issuer module 744 issues authorizations (such as J WTs, etc.) for access to the secure data fabric for vehicle applications as well as other applications, such as wakeup service module 746, FBAS module 730, etc.

Wakeup service module 746 provides an interface for remotely activating an electric vehicle 100 from standby mode, and may communicate with text or SM S server 772. For example, a wakeup command may be received at FBAS module 730 over network 710 from mobile device 716. In response, FBAS module 730 sends an authorization request to authorization module 750 to determine if mobile device 716 has permission to perform the requested operation on the electric vehicle 100 (such as the wakeup command). If authorized, the requested operation is performed. In this example, authorization module 750 determines that mobile device 716 has permission, and sends an approval notification to FBAS module 730. In response, FBAS module 730 sends a query to bootstrap discovery module 760 to determine which cell module 740 is assigned to the particular vehicle ID. Bootstrap discovery module 760 sends a response to FBAS module 730 with the identification of the cell module 740 that is assigned to the particular vehicle ID (such as “01”). Wakeup service module 746 then sends a request to SM S server 772 to wakeup the electric vehicle 100, which powers up from standby mode and initiates a connection to cell module 740.

Fabric message module 748 captures and saves data fabric messages to network data storage 770 for downstream consumption. For example, network data storage 770 may be provided by network server 728, or a network storage device within cloud computing platform 712. Fabric status module 749 may capture certain secure data fabric status information (such as internal advisories from NATS, etc.), and then send the data to network data storage 770 for further analysis.

Authorization module 750 determines whether a request or command received by FBAS 730 has the proper permission, such as a remote command issued by mobile device 716 to a particular electric vehicle 100. In certain embodiments, authorization module 750 employs an authorization model that is formalized using a rights-based system, such as an integrated data management system (IDM S). The formalization of the authorization patterns may be by model and policies, such as role, scope, employee, asset group, etc.

Bootstrap discovery module 760 manages the assignment of electric vehicles 100 to cell modules 740, provides a representational state transfer (REST) interface for electric vehicles 100, receives authorizations (such as J WTs, etc.) for access to the secure data fabric, and provides a lookup service for the metadata for a particular electric vehicle 100. The metadata may include the assigned cell module 740 for each electric vehicle 100, and the associated stream in the secure data fabric.

With respect to the control system 200 of each electric vehicle 100, the TCM EDU 240 may include one or more multi-core processors 222 that execute an operating system that supports high-volume multithreading applications (such as Linux, Unix, BSD, etc.). Various functional modules may be hosted by TCM EDU 240, including fabric gateway 780, fabric controller 782, validator 784, and fabric node 786, web server module 788, as well as other components depicted in FIG. 3B, such as one or more vehicle service modules, one or more feature manager modules, an ECU bus gateway, etc.

Fabric gateway 780 is a component of the secure data fabric that acts as a bridge between vehicle applications, and mobile and network applications. In certain embodiments, fabric gateway 780 may comprise one or more processors, controllers, etc., that are coupled to processor 222 and memory 224 of TCM ECU 240, and are configured to implement the functionality described above. In other embodiments, fabric gateway 780 may comprise one or more software modules that are executed by processor 222 of TCM ECU 240.

Fabric controller 782 manages the streams in the secure data fabric that store and forward messages. In certain embodiments, fabric controller 782 configures and controls NATS server instances executing on TCM ECU 240, manages streams in the secure data fabric on electric vehicle 100, monitors the health of the streams, etc. In certain embodiments, fabric controller 782 may comprise one or more processors, controllers, etc., that are coupled to processor 222 and memory 224 of TCM ECU 240 and configured to implement the functionality described above. In other embodiments, fabric controller 782 may comprise one or more software modules that are executed by processor 222 of TCM ECU 240.

In certain embodiments, validator 784 verifies the integrity and authenticity of data fabric messages that are received by electric vehicle 100. For example, validator 784 may employ certain cryptographic techniques, such as asymmetric cryptography using digital signatures and public/private keys pairs, symmetric cryptography using a shared private key, etc., to verify the integrity and authenticity of data fabric message payloads. In certain embodiments, messages exchanged between fabric hub 742 and fabric node 786 may be encrypted and decrypted using a hash-based message authentication code (HM AC), such as published data and remote commands. In certain embodiments, validator 784 may comprise one or more software modules that are executed by processor 222 of TCM ECU 240. In other embodiments, fabric gateway 780 verifies the integrity and authenticity of data fabric messages that are received by electric vehicle 100.

Fabric node 786 is coupled to fabric gateway 780, fabric controller 782, and validator 784.

Web server module 788 may provide a web server (such as NGINX, etc.) that stores certificates, and may be located between the fabric hub 742 and the fabric node 786. The web server may also provide a secure socket connection between the cell module 740 and the TCM ECU 240 of the electric vehicle 100.

An example data flow through the secure data fabric of communication system 700 will now be described.

Mobile device 716 may send a remote command over network 710 to FBAS 730 that is intended for an electric vehicle 100 with a particular vehicle ID (such as 01-001, etc.), such as a remote command to unlock the driver's door. In response, FBAS module 730 sends an authorization request to authorization module 750 to determine if mobile device 716 has permission to issue this remote command. In this example, authorization module 750 determines that mobile device 716 has permission, and sends an approval notification to FBAS module 730.

In response, FBAS module 730 sends a query to bootstrap discovery module 760 to determine which cell module 740 is assigned to the particular vehicle ID. Bootstrap discovery module 760 sends a response to FBAS module 730 with the identification of the cell module 740 that is assigned to the particular vehicle ID (such as “01”). FBAS module 730 then sends the remote command to fabric hub 742 of the identified cell module 740, which forwards the remote command over network 710 to the identified vehicle 100. TCU ECU 240 of the identified electric vehicle 100 receives the remote command at fabric gateway 780, which forwards the remote command to fabric node 786. Validator 784 may verify the integrity and authenticity of the remote command, and then fabric controller 782 may forward the remote command to the appropriate ECU 220 for execution.

FIG. 7C depicts another block diagram of communication system 700, in accordance with embodiments of the present disclosure. Certain elements of FIG. 7B are depicted in FIG. 7C.

In certain embodiments, control system 200 includes XMM ECU 250 and one or more ECUs 220 that are connected to the secure data fabric. XMM ECU 250 includes fabric node 790, and each ECU 220 connected to the secure data fabric includes fabric extension 792 and VM adaptation layer 794. Fabric node 790 and fabric extension 792 are in communication with fabric node 786. In addition to backend service module 734, data pipeline 736 may also act as a proxy between applications executing on other network devices or in cloud computing platform 712 and the secure data fabric (through FBAS module 730).

Fabric extension 792 and VM adaptation layer 794 advantageously extend the secure data fabric to the ECUs 220, which provides significant advantages. Generally, ECUs 220 play an important role in vehicle systems, such as generating a comprehensive vehicle model that accurately represents the current state and behavior of the vehicle. The vehicle model serves as a valuable resource for various applications, both in the cloud and within the vehicle itself. By extending the secure data fabric to the ECUs 220, the secure data fabric may directly access and leverage the vehicle model generated by the ECUs 220. This advantageously eliminates the need for intermediate layers or complex data transformations, resulting in a more streamlined and efficient communication process. Additionally, extending the secure data fabric to the ECUs 220 also simplifies the technical problem of porting the secure data fabric to different vehicle platforms.

In certain embodiments, fabric extension 792 may be a proprietary extension specifically developed for the secure data fabric and the ECUs 220, which provides tight integration and optimization. In certain other embodiments, fabric extension 792 may be based on a publish-subscribe messaging protocol, such as Message Queuing Telemetry Transport (MQTT), which provides seamless communication between devices and applications. For example, an ECU 220 may publish vehicle model updates as MQTT messages, and an MQTT bridge may receive the MQTT messages and make them available to other applications consuming data over the secure data network.

In certain embodiments, VM adaptation layer 794 transforms the signals received on the ECU 220 into a standardized vehicle model format, and ensures compatibility with the secure data network. In other words, VM adaptation layer 794 bridges the gap between the specific data formats employed by the ECUs 220 and the common vehicle model format used by the secure data fabric. Accordingly, fabric extension 792 and VM adaptation layer 794 seamlessly integrate the secure data fabric with the ECUs 220, and provide access to the vehicle models in a consistent and structured manner.

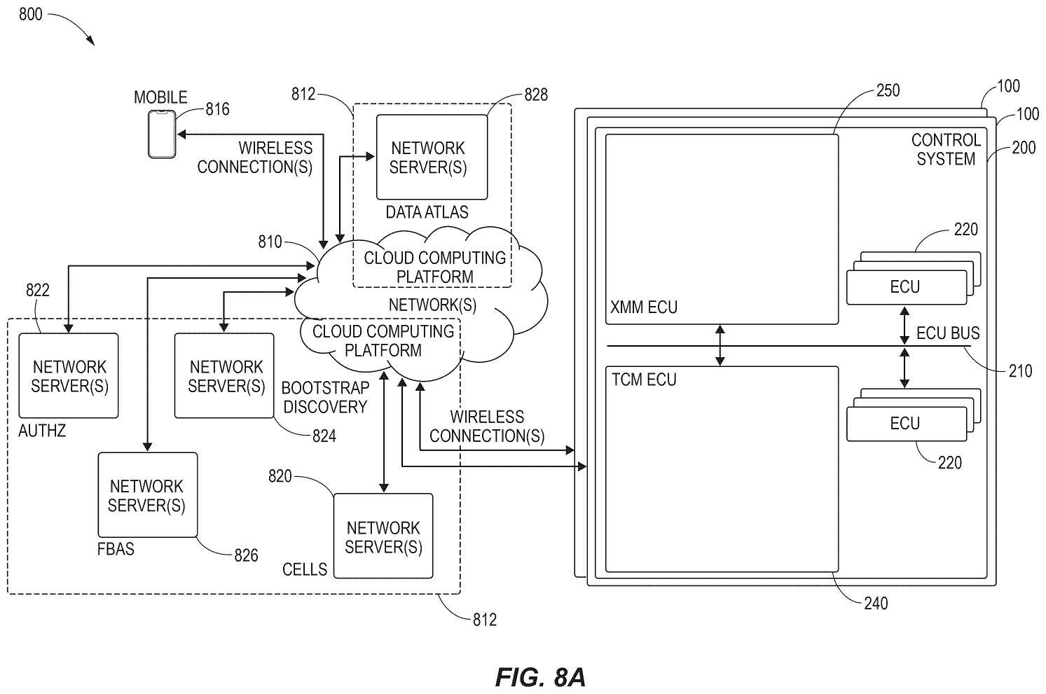

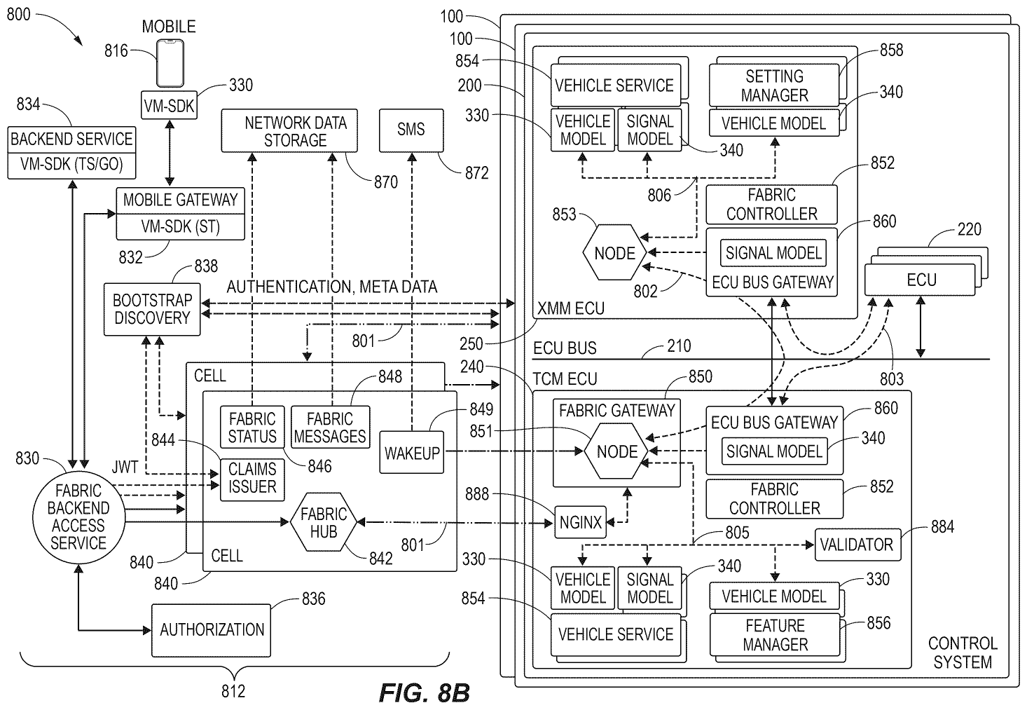

FIG. 8A depicts a block diagram of communication system 800, in accordance with embodiments of the present disclosure.

Generally, communication system 800 combines certain features of communication system 300 with certain features of communication system 700.

In certain embodiments, communication system 800 includes, inter alia, network 810, network devices, such as network servers 820, 822, 824, 826, 828, mobile device(s) 816, personal computer(s), etc., and electric vehicles 100. Each electric vehicle 100 includes a control system 200 with ECUs 220, such as TCM ECU 240 with BT/BLE transceiver 242, WiFi transceiver 244, cellular network transceiver 246, etc. (as depicted in FIG. 2). The architecture of the network devices are described with respect to FIG. 6.

As discussed above with respect to network 310, network 810 may include one or more LANs, wireless LANs (WLANs), WANs (such as the Internet, etc.), etc., which may execute various network protocols, such as, for example, Ethernet, Bluetooth, WiFi, etc. Network 810 may also include various combinations of wired and/or wireless physical layers, such as, for example, copper wire or coaxial cable networks, fiber optic networks, Bluetooth wireless networks, WiFi wireless networks, CDMA, FDMA and TDM A cellular wireless networks, etc.

In certain embodiments, network servers 820, 822, 824, 826, 828 may be coupled to a LAN (or respective LANs) that is coupled to a WAN (such as the Internet, etc.). Mobile device 816 may be coupled to a wireless network (such as a Bluetooth network, a WiFi network, a cellular network, etc.) that is coupled to the WAN. For control system 200 in each electric vehicle 100, BT/BLE transceiver 242 may be coupled to a Bluetooth network device, which is coupled to the WAN. WiFi transceiver 244 may be coupled to a WiFi wireless network which is coupled to the WAN. Cellular network transceiver 246 may be coupled to a CDMA, FDMA or TDMA cellular wireless network, which is coupled to the WAN. Generally, network 810 includes the LANs and WANs necessary to interconnect network servers 820, 822, 824, 826, 828, mobile device 816, and electric vehicles 100.

Network servers 820, 822, 824, 826, 828 provide the functionality necessary to implement the communication messaging protocol within the secure data fabric. In certain embodiments, network servers, 820, 822, 824, 826, 828 may be physical network servers coupled to network 810. In certain other embodiments, network servers, 820, 822, 824, 826, 828 may be “cloud-based” servers (also known as virtual servers) whose functionality is distributed among one or more physical network servers coupled to network 810. For example, a portion of network 810 and these physical network servers may form a “cloud” to which mobile device 816 and electric vehicles 100 may be coupled using wireless LANs. In other words, network servers 820, 822, 824, 826, 828 may provide a cloud computing platform 812 that is configured to provide cloud computing services associated with the secure data fabric.

FIG. 8B depicts another block diagram of communication system 800 depicted in FIG. 8A, in accordance with embodiments of the present disclosure.

In addition to the physical components of communication system 800, certain functional modules, data models, and data flow paths are also depicted. Generally, a functional module may include one or more software modules that are configured to be executed by a local processor or controller, a combination of software modules and programmable logic devices and/or hardware components, etc.

Advantageously, the secure data fabric supports event streams (without state compression), as well as compressed state streams to and from electric vehicle 100. For example, certain remote commands may require event streams from the electric vehicle 100. Each electric vehicle 100 dynamically discovers its metadata using a bootstrap service provided by bootstrap discovery module 838 (as discussed below). Additionally, each vehicle 100 provides a liveness service for authorized subscribers that may be consulted to check the active state of the electric vehicle 100.

In certain embodiments, network server 826 (or cloud computing platform 812) may host Fabric Backend Access Service (FBAS) module 830. Advantageously, FBAS module 830 simplifies the complexity of the interface to the secure data fabric (such as a direct interface to NATS), provides a remote procedure call interface (such as gRPC, etc.) with mutual authentication (such as mTLS, etc.), and supports publication, subscription, requests, and replies. FBAS module 830 is scalable by deploying additional FBAS modules 830 (or instances).

Applications executing on mobile device 816 access vehicle model 330 to provide various services for the user, such as remote start, lock doors, unlock doors, open frunk, locate vehicle, etc. (as discussed above). In certain embodiments, mobile gateway module 832 may act as a proxy between mobile device 816 and the secure data fabric (through FBAS module 830). Similarly, applications executing on other network devices or in cloud computing platform 812 access vehicle model 330 (as discussed above), and backend service module 834 may act as a proxy between these applications and the secure data fabric (through FBAS module 830). In certain embodiments, type script (TS) and GO programming language APIs may be autogenerated from the vehicle model 330, such as VM-SDK (TS) and VM-SDK (TS/GO).

In certain embodiments, network server 820 (or cloud computing platform 812) may host one or more cell modules 840 that provide independent and self-contained units of functionality for a certain number of electric vehicles 100 (such as 1,000 electric vehicles, 10,000 electric vehicles, 100,000 electric vehicles, etc.). Each cell module 840 also supports a certain number of data publications/second, such as 1,000, 10,000, 40,000, etc. Advantageously, cell module 840 is scalable by deploying additional cell modules 840 (or instances) to support additional electric vehicles 100 as the fleet expands.

Each cell module 840 may include, inter alia, fabric hub 842, claims issuer module 844, fabric status module 846, fabric message module 848, and wakeup module 849.

As discussed above, fabric hub 842 is a central component of the secure data fabric, which provides the framework for producer applications to publish data and offer services to consumer applications, and for consumer applications to subscribe to published data and request services from producer applications. In certain embodiments, fabric hub 842 may be a NATS server cluster (as discussed above).

Claims issuer module 844 issues authorizations (such as ] WTs, etc.) for access to the secure data fabric for vehicle applications as well as other applications, such as wakeup service module 846, FBAS module 830, etc.

Wakeup service module 846 provides an interface for remotely activating an electric vehicle 100 from standby mode, and may communicate with text or SM S server 872. For example, a wakeup command may be received at FBAS module 830 over network 810 from mobile device 816. In response, FBAS module 830 sends an authorization request to authorization module 836 to determine if mobile device 816 has permission to perform the requested operation on the electric vehicle 100 (such as the wakeup command). If authorized, the requested operation is performed. In this example, authorization module 836 determines that mobile device 816 has permission, and sends an approval notification to FBAS module 830. In response, FBAS module 830 sends a query to bootstrap discovery module 838 to determine which cell module 840 is assigned to the particular vehicle ID. Bootstrap discovery module 838 sends a response to FBAS module 830 with the identification of the cell module 840 that is assigned to the particular vehicle ID (such as “01”). Wakeup service module 846 then sends a request to SM S server 872 to wakeup the electric vehicle 100, which powers up from standby mode and initiates a connection to cell module 840.

Fabric message module 848 captures and saves data fabric messages to network data storage 870 for downstream consumption. For example, network data storage 870 may be provided by network server 828, or a network storage device within cloud computing platform 812. Fabric status module 849 may capture certain secure data fabric status information (such as internal advisories from NATS, etc.), and then send the data to network data storage 870 for further analysis.

Authorization module 836 determines whether a request or command received by FBAS 830 has the proper permission, such as a remote command issued by mobile device 816 to a particular electric vehicle 100. In certain embodiments, authorization module 836 employs an authorization model that is formalized using a rights-based system, such as an integrated data management system (IDM S). The formalization of the authorization patterns may be by model and policies, such as role, scope, employee, asset group, etc.

Bootstrap discovery module 838 manages the assignment of electric vehicles 100 to cell modules 840, provides a representational state transfer (REST) interface for electric vehicles 100, receives authorizations (such as J WTs, etc.) for access to the secure data fabric, and provides a lookup service for the metadata for a particular electric vehicle 100. The metadata may include the assigned cell module 840 for each electric vehicle 100, and the associated stream in the secure data fabric.

TCM EDU 240 may host various functional modules, including fabric gateway 850, fabric controller 852, one or more vehicle service instances or modules 854 (such as a “body” service module, a “vehicle” service module, etc.), one or more feature manager modules 856, ECU bus gateway 860, validator 784, web server module 788, etc. ECU bus gateway 860 exchanges messages with ECUs 220 over ECU bus 210 (through data flow path 803), and is discussed in more detail with respect to FIG. 3C.

Fabric gateway 850 is a component of the secure data fabric that acts as a bridge between the vehicle applications and the network applications. In certain embodiments, fabric gateway 850 may comprise one or more processors, controllers, etc., that are coupled to processor 222 and memory 224 of TCM ECU 240, and are configured to implement the functionality described above. In other embodiments, fabric gateway 850 may comprise one or more software modules that are executed by processor 222 of TCM ECU 240.

Fabric gateway 850 includes fabric node 851, which is connected to fabric hub 842 through data flow path 801 and to fabric node 853 through data flow path 802. Fabric gateway 850 consumes data from vehicle service modules 854 and feature manager modules 856 through data flow paths 805, and sends data for publication by the secure data fabric to network server 820 through data flow path 801. Fabric gateway 850 also consumes data from the secure data fabric by receiving published data from network server 820 through data flow path 801, and forwards the published data to vehicle service modules 854 and feature manager modules 856 through data flow paths 805. Fabric gateway 850 also forwards the published data to XMM ECU 250 through data flow path 802. Fabric gateway 850 also provides replication of data state and services.

In certain embodiments, fabric hub 842 is a NATS server cluster, and fabric nodes 851 and 853 are NATS leaf nodes, as discussed above. The NATS leaf node on TCM ECU 240 is connected to the NATS server cluster (network server 820) through data flow path 801, and to the NATS leaf node on XMM ECU 250 through data flow path 802. Accordingly, fabric gateway 850 may forward data for publication to the secure data fabric that is received from XMM ECU 250 to network server 820 through data flow path 801. Similarly, fabric gateway 850 may forward published data received from network server 820 to XMM ECU 250 through data flow path 802.

In certain embodiments, fabric gateway 850 may comprise one or more processors, controllers, etc., that are coupled to processor 222 and memory 224 of TCM ECU 240 and configured to implement the functionality described above. In other embodiments, fabric gateway 850 may comprise one or more software modules that are executed by processor 222 of TCM ECU 240.

Fabric controller 852 manages the streams in the secure data fabric that store and forward messages. In certain embodiments, fabric controller 852 configures and controls NATS server instances executing on TCM ECU 240, manages streams in the secure data fabric on electric vehicle 100, monitors the health of the streams, etc. In certain embodiments, the secure data fabric may include bulk streams, event streams, and state streams. A bulk stream from an electric vehicle 100 may include anonymized vehicle data, a pattern of user-selected options or commands, etc. An event stream from an electric vehicle 100 may include remote commands, etc. A state stream from an electric vehicle 100 may include compacted vehicle state data.

In certain embodiments, fabric controller 852 may comprise one or more processors, controllers, etc., that are coupled to processor 222 and memory 224 of TCM ECU 240 and configured to implement the functionality described above. In other embodiments, fabric controller 852 may comprise one or more software modules that are executed by processor 222 of TCM ECU 240.

Each vehicle service instance or module 854 is a vehicle application that accesses vehicle model 330 and signal model 340 to provide data and services to other vehicle applications and network applications. Generally, vehicle model 330 is not dependent upon any particular vehicle platform, while signal model 340 provides the underlying data schema for the particular vehicle platform. Advantageously, vehicle applications and network applications use vehicle model 330 as a standard data model that governs the organization and accessibility of data and services across the secure data fabric. Each vehicle service module 854 maps data defined within signal model 340 to data defined within vehicle model 330. Vehicle platform-specific data and services may be represented as capabilities within vehicle model 330.

Each feature manager module 856 may access vehicle model 330 to provide data and services related to a particular feature within vehicle model 330, such as wireless/Long-Term Evolution (LTE) management, OTA management, etc. In certain embodiments, the data and services may be related to a particular group or subgroup within vehicle model 330, as discussed below.

In certain embodiments, validator 884 verifies the integrity and authenticity of data fabric messages that are received by electric vehicle 100. For example, validator 884 may employ certain cryptographic techniques, such as asymmetric cryptography using digital signatures and public/private keys pairs, symmetric cryptography using a shared private key, etc., to verify the integrity and authenticity of data fabric message payloads. In certain embodiments, messages exchanged between fabric hub 842 and fabric node 851 may be encrypted and decrypted using a hash-based message authentication code (HM AC), such as published data and remote commands. In certain embodiments, validator 884 may comprise one or more software modules that are executed by processor 222 of TCM ECU 240. In other embodiments, fabric gateway 850 verifies the integrity and authenticity of data fabric messages that are received by electric vehicle 100

Web server module 888 may provide a web server (such as NGINX, etc.) that stores certificates, and may be located between the fabric hub 842 and the fabric node 851. The web server may also provide a secure socket connection between the cell module 840 and the TCM ECU 240 of the electric vehicle 100.

XMM ECU 250 may host various functional modules, including one or more vehicle service modules 854 such as an “energy” service module, an “audio” service module, an “hvac” service module, etc.), one or more setting manager modules 858, ECU bus gateway 860, etc. XMM ECU 250 may also host a fabric controller 852, as discussed above. Each setting manager module 858 may access vehicle model 330 to provide data and services related to a particular setting within vehicle model 330, such as energy management, audio/amplifier management, Heating, Ventilation, and Air Conditioning (HVAC) management, etc.

Fabric node 853 consumes data from vehicle service modules 854 and setting manager modules 858 through data flow paths 806, and sends data for publication by the secure data fabric to fabric gateway 850 through data flow path 802 for transmission to network server 820 through data flow path 801. Fabric node 853 also consumes data from the secure data fabric by receiving published data (originating from network server 820) from fabric gateway 850 through data flow path 802, and forwards the published data to vehicle service modules 854 and setting manager modules 858 through data flow paths 806.

An example data flow through the secure data fabric of communication system 800 will now be described.

Mobile device 816 may send a remote command over network 810 to FBAS 830 that is intended for an electric vehicle 100 with a particular vehicle ID (such as 01-001, etc.), such as a remote command to unlock the driver's door. In response, FBAS module 830 sends an authorization request to authorization module 836 to determine if mobile device 816 has permission to issue this remote command. In this example, authorization module 836 determines that mobile device 816 has permission, and sends an approval notification to FBAS module 830.

In response, FBAS module 830 sends a query to bootstrap discovery module 838 to determine which cell module 840 is assigned to the particular vehicle ID. Bootstrap discovery module 838 sends a response to FBAS module 830 with the identification of the cell module 840 that is assigned to the particular vehicle ID (such as “01”). FBAS module 830 then sends the remote command to fabric hub 842 of the identified cell module 840, which forwards the remote command over network 810 to the identified vehicle 100. TCU ECU 240 of the identified electric vehicle 100 receives the remote command at fabric node 851 of fabric gateway 850. Validator 884 may verify the integrity and authenticity of the remote command, and then fabric controller 852 may forward the remote command to the appropriate ECU 220 for execution.

The many features and advantages of the disclosure are apparent from the detailed specification, and, thus, it is intended by the appended claims to cover all such features and advantages of the disclosure which fall within the scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A communication system, comprising:
at least one network server in communication with a network, the network server configured to provide a secure data fabric, the secure data fabric comprising fabric hubs, a vehicle model, a signal model, and a first protocol;
a network device in communication with the network and connected to the secure data fabric, the network device configured to exchange messages with the network server according to the first protocol, the messages including data from the vehicle model; and
at least one vehicle in communication with the network and connected to the secure data fabric, the vehicle comprising:
electronic control units (ECUs) connected to an ECU bus, the ECUs including:
a first ECU including a fabric node in communication with one of the fabric hubs,
wherein the first ECU is configured to:
exchange messages with the fabric hub according to the first protocol, the messages including the data from the vehicle model,
convert the data from the vehicle model to data from the signal model, and
exchange messages with the ECUs according to a second protocol, the messages including the data from the signal model.

2. The communication system of claim 1, wherein:
the secure data fabric further comprises cell modules;
each cell module includes one of the fabric hubs; and
each cell module is configured to exchange messages with a number of vehicles.

3. The communication system of claim 2, wherein the secure data fabric further comprises:
a fabric backend access service (FBAS) configured to:
exchange messages with the network device according to the first protocol, and
exchange messages with the fabric hub of each cell according to the first protocol.

4. The communication system of claim 3, wherein:
the first protocol includes publication and subscription services, and request and response services;
the FBAS publishes data received from the network device for subscription by one or more functional modules hosted by the ECUs; and
the FBAS publishes data received from functional modules hosted by the ECUs for subscription by the network device.

5. The communication system according to claim 4, wherein the first protocol is Neural Autonomic Transport System (NATS), and the second protocol is controller area network (CAN).

6. A communication system, comprising:
at least one network server in communication with a network, the network server configured to provide a secure data fabric, the secure data fabric comprising:
a fabric hub,
a vehicle model,
a signal model, and
a first protocol including publication and subscription;
a network device in communication with the network and connected to the secure data fabric, the network device configured to exchange messages with the network server according to the first protocol, the messages including data from the vehicle model; and
at least one vehicle in communication with the network and connected to the secure data fabric, the vehicle comprising:
electronic control units (ECUs) connected to an ECU bus, the ECUs including:
a first ECU including a fabric node in communication with the fabric hub, wherein the first ECU is configured to:
exchange messages with the fabric hub according to the first protocol, the messages including the data from the vehicle model,
convert the data from the vehicle model to data from the signal model, and
exchange messages with the ECUs according to a second protocol, the messages including the data from the signal model.

7. The communication system of claim 6, wherein the first protocol is Neural Autonomic Transport System (NATS), and the second protocol is controller area network (CAN).

8. The communication system of claim 6, wherein the signal model defines vehicle signals generated by the ECUs.

9. The communication system of claim 8, wherein:
the vehicle model defines properties and services for the vehicle;
the properties include vehicle data that are mapped to the vehicle signals defined in the signal model; and
the services include remote procedures that are based on the vehicle data.

10. The communication system of claim 9, wherein:
the network device is further configured to subscribe to one or more properties and services in the vehicle model; and
the first ECU is further configured to publish one or more properties and services in the vehicle model.

11. The communication system of claim 10, wherein the network server is further configured to:
confirm that the network device is authorized to subscribe to the one or more properties and services in the vehicle model; and
confirm that the first ECU is authorized to publish the one or more properties and services in the vehicle model.

12. The communication system of claim 11, wherein the network server is further configured to:
grant authorization to the network device to subscribe to the one or more properties and services in the vehicle model; and
grant authorization to the first ECU to publish the one or more properties and services in the vehicle model.

13. The communication system of claim 9, wherein:
the network device is further configured to:
provide a graphical user interface (GUI) based on the vehicle model to a user, the GUI including vehicle data and one or more selectable remote procedures,
receive, from the one or more selectable remote procedures, a selected remote procedure from the user, and
send a service request message to the network server over the network according to the first protocol, the service request message including the selected remote procedure;
the network server is further configured to forward the service request message to the vehicle over the network according to the first protocol; and
the first ECU is further configured to:
receive the service request message, and
execute the selected remote procedure.

14. The communication system of claim 13, wherein the network server is further configured to confirm that the network device is authorized to request the selected remote procedure before forwarding the service request message to the vehicle.

15. The communication system of claim 6, wherein:
the first ECU comprises:
an ECU bus gateway coupled to the ECU bus, the ECU bus gateway including the signal model,
a wireless transceiver coupled to the network,
a fabric gateway coupled to the wireless transceiver, and
a processor coupled to the fabric gateway and the ECU bus gateway, the processor configured to execute one or more vehicle service instances, each vehicle service instance including the vehicle model and the signal model, and each vehicle service instance configured to manage data within the vehicle model and perform remote procedures based on the managed data; and
a second ECU comprises a processor configured to:
generate the data from the signal model, and
send messages over the ECU bus to the first ECU according to the second protocol, the messages including the data from the signal model.

16. A communication system, comprising:
at least one network server in communication with a network, the network server configured to provide a secure data fabric, the secure data fabric comprising:
cell modules, each cell module including a fabric hub, and
a first protocol including publication and subscription;
a network device in communication with the network and connected to the secure data fabric, the network device configured to exchange messages with the network server according to the first protocol; and
at least one vehicle in communication with the network and connected to the secure data fabric, the vehicle comprising:
electronic control units (ECUs) connected to an ECU bus, the ECUs including:
a first ECU including a fabric node in communication with the fabric hub of one of the cell modules,
wherein the first ECU is configured to:
exchange messages with the fabric hub according to the first protocol, and
exchange messages with the ECUs according to a second protocol.

17. The communication system of claim 16, wherein the secure data fabric further comprises:
a fabric backend access service (FBAS) configured to:
exchange messages with the network device according to the first protocol, and
exchange messages with the fabric hub of each cell according to the first protocol.

18. The communication system of claim 17, wherein:
the FBAS publishes data received from the network device for subscription by one or more functional modules hosted by the ECUs; and
the FBAS publishes data received from functional modules hosted by the ECUs for subscription by the network device.

19. The communication system of claim 16, wherein the first protocol is Neural Autonomic Transport System (NATS), and the second protocol is controller area network (CAN).

20. The communication system of claim 16, wherein each cell module is configured to exchange messages with a number of vehicles.
